(19) United States
(12) Patent Application Publication
(10) Pub. No.: US 2023/0024254 A1
(43) Pub. Date: Jan. 26, 2023

(54) Gesture Controls Using Ultra Wide Band

(71) Applicant: Google LLC, Mountain View, CA (US)

(72) Inventors: Shengzhi Wu, Shenzhen (CN); Alexander James Faaborg, Mountain View, CA (US)

(21) Appl. No.: 17/385,433

(22) Filed: Jul. 26, 2021

(51) Int. Cl. G08C 17/02

(52) U.S. Cl. CPC G08C 17/02; G08C 2201/32

(57) ABSTRACT

The present disclosure provides for device localization using ultra wide band (UWB) detection and gesture detection using inertial measurement units (IMUs) on one or more wearable devices to control smart devices, such as home assistants, smart lights, smart locks, etc.

### BACKGROUND

Smart home controls largely rely on voice and screen-based interactions, but voice interaction isn't ideal at some times, such as when other people are sleeping, and screen-based interactions can be cumbersome to go through a few screens to get to the desired control.

### BRIEF SUMMARY

One aspect of the disclosure method for controlling a smart home device using a wearable device, comprising detecting, by the smart home device using ultrawide band (UWB), engagement of the smart home device by the wearable device, initiating, in response to detecting the engagement, a control mode, receiving signals from the wearable device, the signals corresponding to a command associated with gestures detected by the wearable device, performing an action associated with the command, detecting disengagement of the wearable device, and exiting the control mode.

According to some examples, detecting the engagement of the smart home device includes detecting a relative position of the wearable device with respect to the smart home device. Detecting the relative position may include determining that the relative position has remained unchanged for a predetermined threshold of time. The wearable device may be a smartwatch worn on the user's arm, wherein the relative position is the smartwatch being pointed at the smart home device.

According to some examples, the method may further include receiving, from a second smart home device, the wearable device as detected by the second smart home device using UWB, and determining, based on combined UWB information from the smart home device and the second smart home device, an orientation of the user.

Initiating the control mode may include listening, by the smart home device, for signals from the wearable device. Detecting disengagement may include detecting that the wearable device changed position relative to the smart home device. According to other examples, detecting disengagement may include detecting that a predetermined threshold of time has passed after initiating the control mode.

According to some examples, the method may further include receiving, by the smart home device, additional sensor data from at least one of the wearable device or a second wearable device, and determining the command based on a combination of the received signals and the additional sensor data.

Another aspect of the disclosure provides a system for controlling a smart home device using a wearable device, comprising memory storing executable instructions, and one or more processors in communication with the memory. The one or more processors may be configured to detect, using ultrawide band (UWB), engagement of the smart home device by the wearable device, initiate, in response to detecting the engagement, a control mode, receive signals from the wearable device, the signals corresponding to a command associated with gestures detected by the wearable device, perform an action associated with the command, detect disengagement of the wearable device, and exit the control mode.

Yet another aspect of the disclosure provides a non-transitory computer-readable medium storing instructions executable by one or more processors, the instructions for performing a method of controlling a smart home device, comprising detecting, using ultrawide band (UWB), engagement of the smart home device by the wearable device, initiating, in response to detecting the engagement, a control mode, receiving signals from the wearable device, the signals corresponding to a command associated with gestures detected by the wearable device, performing an action associated with the command, detecting disengagement of the wearable device, and exiting the control mode.

### BRIEF DESCRIPTION OF THE DRAWINGS

FIGS. 1A-B are pictorial diagrams illustrating an example system according to aspects of the disclosure.

FIG. 2 is a block diagram illustrating an example system according to aspects of the disclosure.

FIGS. 3-4 are pictorial diagrams illustrating example gestures according to aspects of the disclosure.

FIG. 5 is an aerial perspective of an example implementation including multiple smart home devices according to aspects of the disclosure.

FIG. 6 is a flow diagram illustrating an example method according to aspects of the disclosure.

### DETAILED DESCRIPTION

The present disclosure provides for device localization using ultra wide band (UWB) detection and gesture detection using inertial measurement units (IMUs) on one or more wearable devices to control smart devices, such as home assistants, smart lights, smart locks, etc.

UWB chips may reside on both wearable devices, such as smart watches, wrist bands, etc., and on smart home devices, such as smart speakers, smart lights, smart locks, etc. These UWB chips may be used to localize a relative orientation and position between the wearable device and smart home device, such that it can be detected when a user is pointing at a certain device. For example, using the localization between the smart home device and a smart watch on the user's wrist, it can be detected when the smart watch on the user's wrist is pointing at the smart home device. Once the user pauses his/her arm and keeps pointing at the device for a predefined threshold of time, such as 1 second, the smart home device and the wearable device may automatically enter a device control mode, where gestures by the user will control operation of the smart home device. According to some examples, one or both of the wearable or the smart home device may provide an indication that device control mode is active. For example, the smart watch may provide haptic feedback and/or visuals.

Once the devices are in the device control mode, gestures may be detected by the IMUs on the wearable device. For example, the user can raise the palm facing the device, the raising palm gesture could be detected by the IMU on the smart watch. Such detection by the IMUs may be used to initiate a pause control to the smart home device, such as to make content being played by the smart home device pause. Initiating the control may include, for example, transmitting a signal from the smart watch to the smart home device.

It should be understood that this is only one example of numerous different possible gestures and commands detected between different devices. By way of example only, the IMUs and/or other sensors in the wearable may detect gestures such as wrist rotation, arm movements, head movements, swipe gestures, vertical or lateral hand movements, squeeze gestures, etc. Control commands initiated by the gestures may include, by way of example only, changing volume, brightness, room temperature, locking/unlocking doors, changing content played, etc.

Exiting the control mode may be performed based on either or both of detected gestures of the users or passage of a predetermined amount of time. As an example gesture, when the IMUs in the wearable detect that the user put the user's arm down and/or is no longer facing the smart home device, the control mode may be exited.

By using UWB to detect when the control mode should be entered and exited, data acquisition by other sensors may be limited. For example, the home device need not have a camera for obtaining images of the gestures, and if it does have a camera that camera does not need to be on continually or at all to receive the gesture commands.

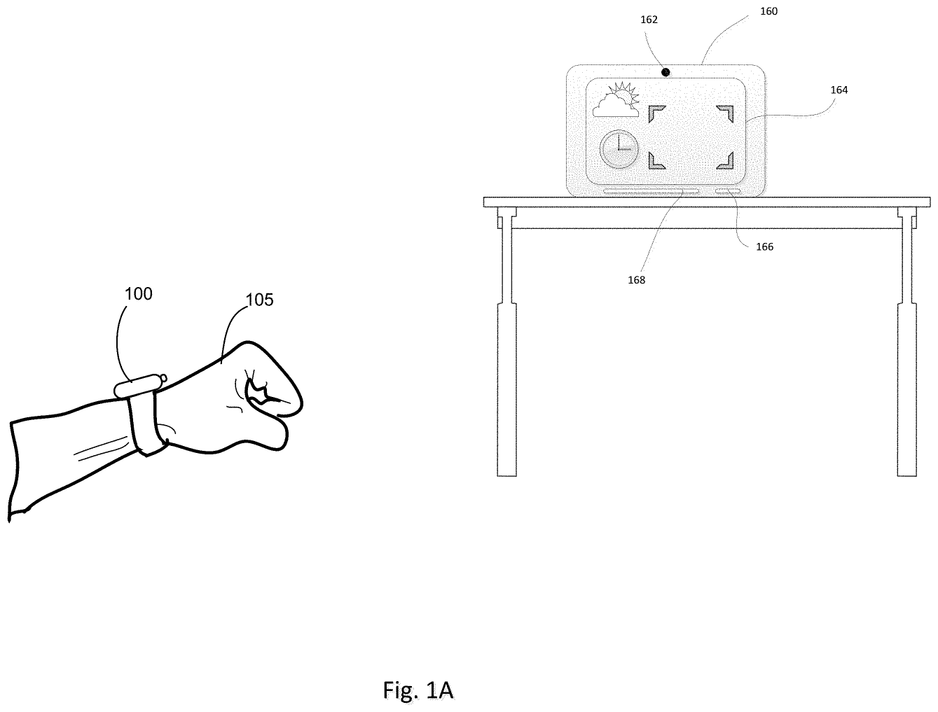

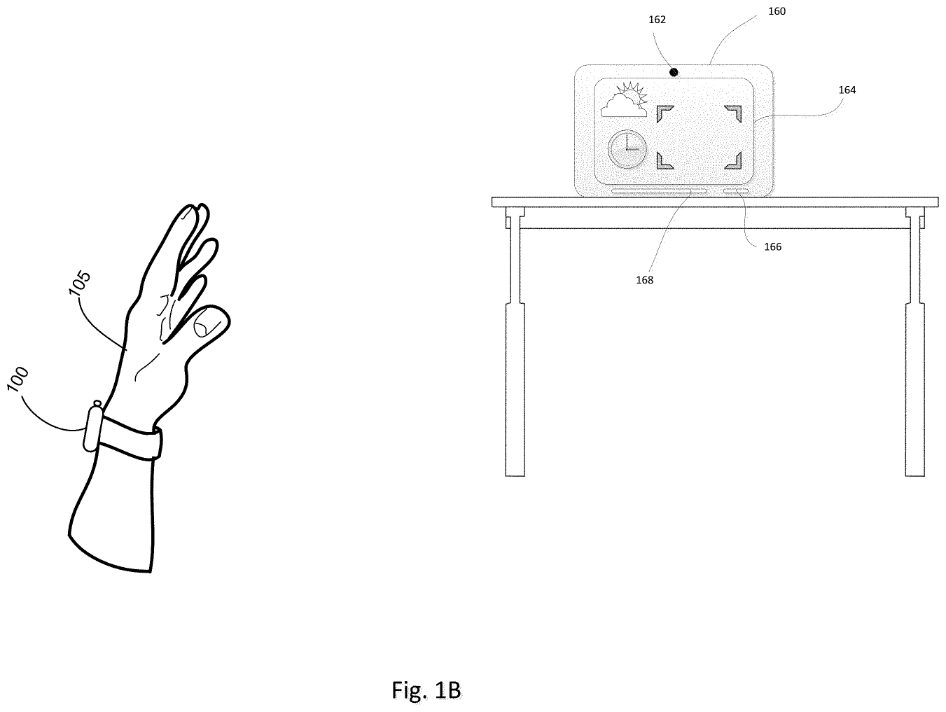

FIGS. 1A-B are pictorial diagrams of an example system, including one or more wearable devices 100 worn by a user and one or more smart home devices 160. Each of the wearable device 100 and the smart home device 160 may be equipped with UWB sensors, such that the smart home device 160 can detect when the wearable 100 is pointed at the smart home device 160. In response, the smart home device 160 may enter a control mode in which gestures by the user wearing the wearable device 100 may be used to control the smart home device 160.

While in each of FIGS. 1A-B, the user is wearing a smartwatch on the user's wrist, it should be understood that the wearable device may include any type of wearable, such as smart glasses, a fitness tracking band, an augmented reality or virtual reality headset, or any other wearable electronic device that includes one or more sensors and is capable of electronic communication with nearby devices. Moreover, while the examples illustrate a single wearable device, multiple wearable devices of different types may be used.

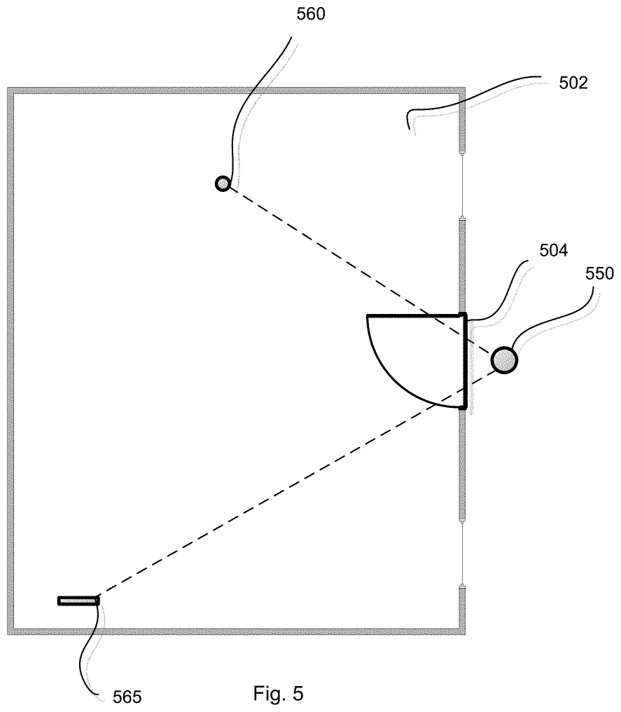

Similarly, in the examples shown the smart home device 160 is a home assistant hub that also includes a display 164, microphone 166, and speaker 168. However, it should be understood that any of a variety of types of smart home devices may be used that may or may not have displays, speakers, or other features. Examples of other types of smart home devices include smart TVs, streaming devices, home monitoring systems, smart lights, door locks, thermostats, speakers, smart displays, etc. While one smart home device 160 is shown in FIGS. 1A-B, in some examples multiple smart home devices may be used, such as a secondary smart home device being used to determine an orientation of the user. Such examples are further discussed below in connection with FIG. 5.

The wearable device 100 and smart home device 160 may be in wireless communication with one another. For example, the wearable device 100 and smart home device 160 may be paired using short range wireless pairing, such as Bluetooth, Bluetooth low energy (BLE), UWB, or any of a variety of other wireless pairing techniques. In some instances, the wearable device 100 and the smart home device 160 may be indirectly wirelessly coupled through the Internet, a local area network, or any other type of network.

In FIG. 1A, the user's arm 105 is pointed at the smart home device 160. UWB sensors on the wearable device 100 and/or the smart home device 160 may detect the proximity or distance between the devices. Moreover, IMUs on the wearable device 100 may detect a general orientation of the user's hand 105, with arm raised such that it is pointed towards the smart home device 106. Such detection of the wearable device 100 pointed at the smart home device 160 may trigger a control mode, where gestures detected by the wearable device 100 may be used to signal commands to the smart home device 160. According to some examples, the command mode may be entered after the pointing gesture is held for a predetermined period of time, such as half a second, a second, etc.

FIG. 1B illustrates the user's arm 105 commanding the smart home device 160 using gestures. In particular, the user's hand is raised to extend vertically, such as in a “stop” or “pause” hand gesture. As the user's arm 105 makes this gesture, the wearable device 100 on the user's wrist is angled upwards. Such change is position of the wearable device 100 may be detected by IMUs, such as gyroscope, accelerometer, etc., in the wearable device. In some examples, such IMU measurements may be combined with the UWB sensor measurements to determine a position of the wearable device 100, such that a corresponding gesture and command may be identified. In other examples, the IMU measurements may be used alone to identify the gesture and command, or they may be used in combination with measurements from any of a variety of other sensors, such as cameras, microphones, photoplethysmogram (PPG) sensors, strain gauges, etc.

The system described herein provides for improved user experience, as a user can quietly and quickly manipulate a smart home device using only the hand on which the smartwatch is being worn.

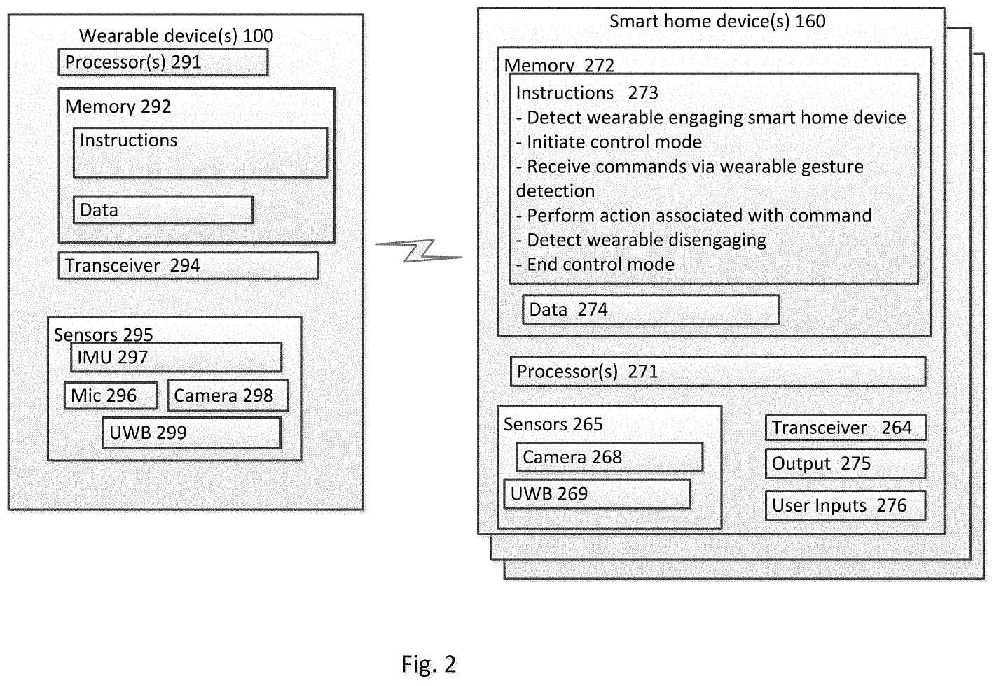

FIG. 2 further illustrates example computing devices in the system, and features and components thereof. While the example illustrates one wearable devices in communication with one smart home device, additional wearable and/or smart home devices may be included. According to some examples, processing of signals and determination of gestures may be performed at a single device, such as the wearable device 100 or the smart home device 160. According to other examples, processing may be performed by different processors in the different devices in parallel, and combined at one or more devices.

The wearable device 100 includes various components, such as a processor 291, memory 292 including data and instructions, transceiver 294, sensors 295, and other components typically present in wearable wireless computing devices. The wearable device 100 may have all of the components normally used in connection with a wearable computing device such as a processor, memory (e.g., RAM and internal hard drives) storing data and instructions, user input, and output.

The wearable device 100 may also be equipped with short range wireless pairing technology, such as a Bluetooth transceiver, allowing for wireless coupling with other devices. For example, transceiver 294 may include an antenna, transmitter, and receiver that allows for wireless coupling with another device. The wireless coupling may be established using any of a variety of techniques, such as Bluetooth, Bluetooth low energy (BLE), ultra wide band (UWB), etc.

The sensors 295 may be capable of detecting the user's movements, in addition to detecting other parameters such as relative proximity to other devices, etc. The sensors may include, for example, IMU sensors 297, such as an accelerometer, gyroscope, etc. For example, the gyroscopes may detect inertial positions of the wearable device 100, while the accelerometers detect linear movements of the wearable device 100. Such sensors may detect direction, speed, and/or other parameters of the movements. The sensors may additionally or alternatively include any other type of sensors capable of detecting changes in received data, where such changes may be correlated with user movements. For example, the sensors may include a barometer, motion sensor, temperature sensor, a magnetometer, a pedometer, a global positioning system (GPS), proximity sensor, strain gauge, camera 298, microphone 296, UWB sensor 299, etc. The one or more sensors of each device may operate independently or in concert.

The proximity sensor or UWB sensor may be used to determine a relative position, such as angle and/or distance, between two or more devices. Such information may be used to detect a relative position of devices, and therefore detect a relative position of the user's body parts on which the wearable devices are worn.

The strain gauge may be positioned, for example, in the smartwatch such as in a main housing and/or in a band of the smartwatch. Thus, for example, as a user's arm tenses, such as when the user performs a fist-clenching gesture, the strain gauge may measure an amount of tension. According to some examples, measurements of the strain gauge may be used to measure how much weight is being lifted.

The IMU sensor 297 may generate a three-dimensional signal which provides information about the direction and speed of the sensor movement. Features may be extracted from the IMU signal to help determine whether arm or wrist movement is involved when the signal is collected.

The smart home device 160 may include components similar to those described above with respect to the wearable device. For example, the smart home device 160 may include a processor 271, memory 272, transceiver 264, and sensor 265. Such sensors may include, without limitation, one or more cameras 268 or other image capture devices, such as thermal recognition, etc., UWB sensor 269, and any of a variety of other types of sensors.

The camera 268 may capture images of the user, provided that the user has configured the smart home device 160 to enable the camera and allow the camera to receive input for use in association with other devices in detecting gestures. The captured images may include one or more image frames, video stream, or any other type of image. Image recognition technique may be used to identify a shape or outline of the user's gesture. However, image capture is not needed to determine the gestures, and gesture determination may be performed by smart home devices without cameras or without activating the cameras.

Input 276 and output 275 may be used to receive information from a user and provide information to the user. The input may include, for example, one or more touch sensitive inputs, a microphone, a camera, sensors, etc. Moreover, the input 276 may include an interface for receiving data from the wearable device 100 and/or other wearable devices or other smart home devices. The output 275 may include, for example, a speaker, display, haptic feedback, etc.

The one or more processor 271 may be any conventional processors, such as commercially available microprocessors. Alternatively, the one or more processors may be a dedicated device such as an application specific integrated circuit (ASIC) or other hardware-based processor. Although FIG. 2 functionally illustrates the processor, memory, and other elements of the smart home device 160 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of smart home device 160. Accordingly, references to a processor or computing device will be understood to include references to a collection of processors or computing devices or memories that may or may not operate in parallel.

Memory 272 may store information that is accessible by the processors 271, including instructions 273 that may be executed by the processors 271, and data 274. The memory 272 may be of a type of memory operative to store information accessible by the processors 271, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 273 and data 274 are stored on different types of media.

Data 274 may be retrieved, stored or modified by processors 271 in accordance with the instructions 273. For instance, although the present disclosure is not limited by a particular data structure, the data 274 may be stored in computer registers, in a relational database as a table having a plurality of different fields and records, XML documents, or flat files. The data 274 may also be formatted in a computer-readable format such as, but not limited to, binary values, ASCII or Unicode. By further way of example only, the data 274 may be stored as bitmaps comprised of pixels that are stored in compressed or uncompressed, or various image formats (e.g., JPEG), vector-based formats (e.g., SVG) or computer instructions for drawing graphics. Moreover, the data 274 may comprise information sufficient to identify the relevant information, such as numbers, descriptive text, proprietary codes, pointers, references to data stored in other memories (including other network locations) or information that is used by a function to calculate the relevant data.

The instructions 273 may be executed to detect when the wearable device 100 is pointed at the smart home device 160, such as to engage the command mode. For example, the processor 271 may receive signals from the UWB 269 to determine when the wearable device 100 is held at a relative position with respect to the smart home device 160 for a predetermined amount of time. Moreover, the instructions 273 may be executed to initiate a control mode, receive commands from the wearable device using gesture detection, and perform actions associated with such commands. Moreover, the instructions 273 may be executed to detect when the wearable device 100 is disengaging from the control mode, such as when the user puts down the user's arm, and in response exits the control mode.

While the processor 271 and memory 272 of the smart home device 160 are described in detail, it should be understood that the processor 291 and memory 292 of the wearable device 100 may include similar structure, features, and functions. In addition, the instructions of the wearable device may be executed by the processor 291 to detect particular gestures using sensor data from the IMU 297 and/or one or more other sensors 295.

Machine learning models may be trained to provide a gesture recognizer. Examples of such machine learning models may include K-Nearest Neighbor, Random Forests, Recurrent Neural Networks, etc.

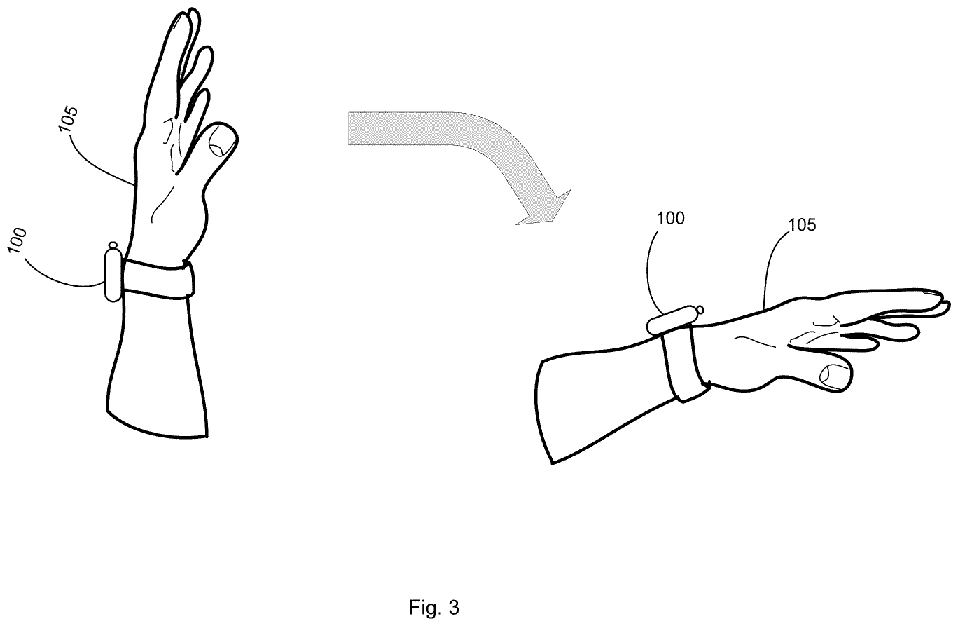

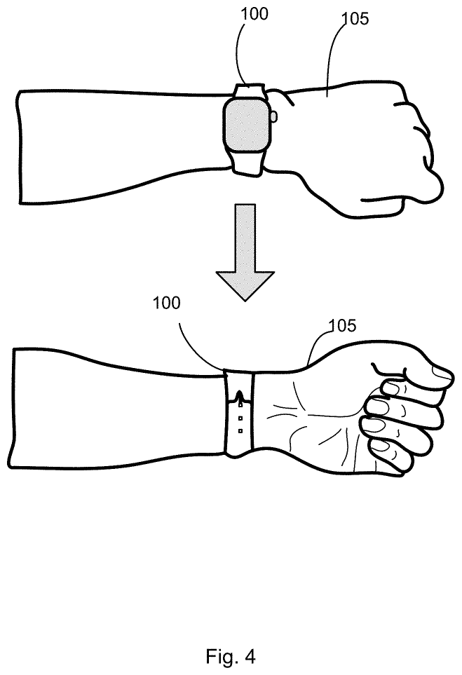

FIGS. 3-4 illustrates different example gestures. Each of the gestures may be performed with one hand 105 wearing a smartwatch 100 or other wearable computing device. While a couple example gestures are shown, it should be understood that any number of additional one-handed gestures may also be recognized to issue a particular command to the smart home device 160.

FIG. 3 illustrates a first example gesture, where the user moves the hand in approximately a 90 degree arc by rotating at the elbow. This may be used to, for example, issue a command to close an application, lock a door, turn off a smart light, etc.

FIG. 4 illustrates a second example gesture, such as a rotate gesture, where the user rotates the extended arm about a horizontal axis. Just some examples of functions activated by the second gesture may include adjusting brightness, adjusting volume, etc. According to some examples, a degree of the rotation may correspond to different functions. For example, a quarter turn of the wrist may correspond to one command while a half turn of the wrist corresponds to a different command. According to other examples, the degree of rotation may correspond to a degree of change in the smart home device. For example, a small degree of rotation may correspond to small increase in volume, while a larger degree of rotation may correspond to a larger increase in volume. Similarly, a direction of rotation may correspond to variations in the command. For example, rotation in a right direction may correspond to an increase in volume command while rotation in a left direction may correspond to a decrease in volume command.

The examples above illustrate only a couple of many possible gestures. Some additional examples, without limitation, include swiping left/right or up/down, waving, pinching, first clenching, etc.

FIG. 5 illustrates an example implementation including multiple smart home devices, which may be used to detect both location and orientation of the user using UWB. As shown, user 550 is standing at a door 504 of a building 502, such as the user's home. Inside the building 502 is a first smart home device 560 and a second smart home device 565. The door 504 may include a smart lock that includes its own controls or is controlled by one or more of the other smart home devices 560, 565. The user 550 may be wearing one or more wearable electronic devices, such as a smartwatch, smartglasses, earbuds, pendant, ring, smart cloth clothing, etc. UWB sensors in the first and second smart home devices 560, 565 may detect a relative proximity of the user 550 to each device. Combining such information, a location and orientation of the user 550 may be determined. For example, if each smart home device detects a distance of the wearable in any direction around the smart home device, the position of the user may be extrapolated where the two distances intersect. In other examples, one device could have both proximity and angle, and therefore may be used to position the user relative to a device that does not have UWB, provided that the other device's position is known or was learned at some point. This information may be used to more accurately detect when the user is intending to engage control mode by performing a particular gesture. In this example, engaging control mode may be performed simply by the user standing in front of and facing the door 504. For security, account information for the wearable device worn by the user 550 may be compared with account information of the first and second smart home devices 560, 565 to confirm that gestures of the user 550 should be accepted as commands. Accordingly, the user 550 may gesture to unlock the door 504, and such gestures may be detected by the user's wearable device and communicated to the smart lock in the door 504 directly and/or indirectly through the first/second smart home devices 560, 565.

According to some information, historic information may be collected by either or both of the smart home devices 560, 565 and used to more accurately determine a position of the user 550. For example, the UWB sensors in the smart home device 565 may detect proximity and relative location of other devices in the room over time. Additionally or alternatively, the smart home device 565 may detect where walls of the room are located. For example, using UWB, it may be detected where users walk, and then the walls and doors may be inferred based on all of those walk paths. In other examples, devices can emit ultrasound pings, and then a device on the user, such as a wearable or mobile device, listens for them. Because ultrasound doesn't travel through wads, the positions of the walls may be inferred. This information may be used to more accurately detect when a user is performing an action intended to engage control mode, such as by pointing an arm at the smart home device.

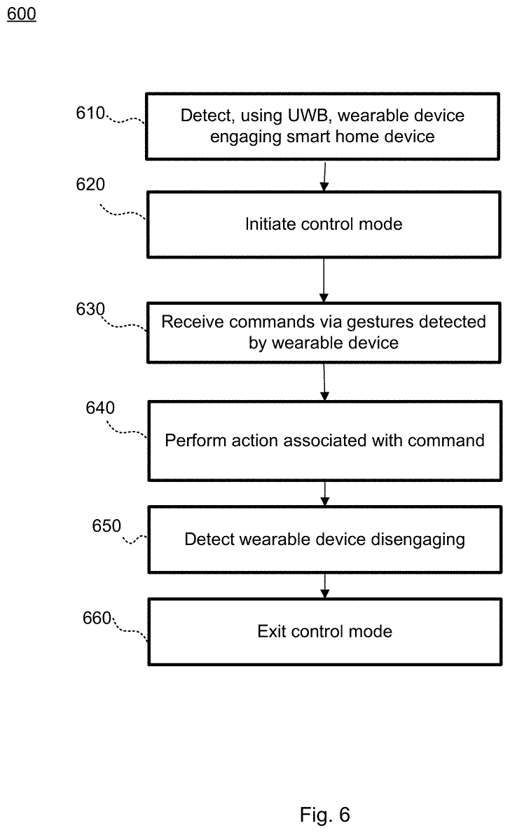

FIG. 6 is a flow diagram illustrating an example method 600 of using UWB and IMU of a wearable device to control a smart home device. The wearable device may be a smartwatch or other wearable electronic device, such as a fitness tracker, gloves, ring, wristband, etc. with integrated electronics. While the operations are illustrated and described in a particular order, it should be understood that the order may be modified and that operations may be added or omitted.

In block 610, the smart home device detects, using UWB, that the wearable device is positioned in a way intended to engage the smart home device. For example, where the wearable device is a smart watch, the user's arm wearing the watch may be pointed at the smart home device.

In block 620, the smart home device initiates a control mode. In such mode, the smart home device is listening for commands from the wearable device.

In block 630, the smart home device receives commands via gestures detected by the wearable device. For example, IMUs in the wearable device may detect movements of the user's hand, arm, or other relevant body part. The smart home device may receive either raw sensor data from the IMUs, or may receive command signals from the wearable device which the wearable device associated with particular gestures that correspond to the raw sensor data.

In block 640, the smart home device performs an action associated with the command. For example, where a raised flexed hand gesture is detected by the IMUs, such gesture may correspond to “stop” or “pause” command. Accordingly, the smart home device may take a corresponding action, such as stopping music, video, or other content being played, or stopping a timer, etc.

In block 650, the smart home device may detect disengagement of the wearable device, for example using the UWB sensors. For example, the smart home device may detect that the user's arm wearing the smart watch was lowered and/or moved away from the smart home device.

In block 660, the smart home device exits the control mode. As such, the smart home device may no longer listen for commands from the wearable device until a subsequent engagement is detected using the UWB.

The foregoing systems and methods are beneficial in that user experience is improved because users can enter input to the smart home device using the wearable, but without needing to interact with small form factor displays or other inputs on the wearable. Additionally, the user may control the home device without verbal commands, which is beneficial in a number of scenarios, such as if the user is in conversation, the user has difficulty with speech, the user is trying to maintain quiet such as to avoid waking or interrupting someone, etc.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for controlling a smart home device using a wearable device, comprising:
detecting, by the smart home device using ultrawide band (UWB), engagement of the smart home device by the wearable device;
initiating, in response to detecting the engagement, a control mode;
receiving signals from the wearable device, the signals corresponding to a command associated with gestures detected by the wearable device;
performing an action associated with the command;
detecting disengagement of the wearable device; and
exiting the control mode.

2. The method of claim 1, wherein detecting the engagement of the smart home device comprises detecting a relative position of the wearable device with respect to the smart home device.

3. The method of claim 2, wherein detecting the relative position comprising determining that the relative position has remained unchanged for a predetermined threshold of time.

4. The method of claim 2, wherein the wearable device is a smartwatch worn on the user's arm.

5. The method of claim 4, wherein the relative position is the smartwatch being pointed at the smart home device.

6. The method of claim 1, further comprising:
receiving, from a second smart home device, the wearable device as detected by the second smart home device using UWB; and
determining, based on combined UWB information from the smart home device and the second smart home device, an orientation of the user.

7. The method of claim 1, wherein initiating the control mode comprises listening, by the smart home device, for signals from the wearable device.

8. The method of claim 1, wherein detecting disengagement comprises detecting that the wearable device changed position relative to the smart home device.

9. The method of claim 1, wherein detecting disengagement comprises detecting that a predetermined threshold of time has passed after initiating the control mode.

10. The method of claim 1, further comprising receiving, by the smart home device, additional sensor data from at least one of the wearable device or a second wearable device; and
determining the command based on a combination of the received signals and the additional sensor data.

11. A system for controlling a smart home device using a wearable device, comprising:
memory storing executable instructions; and
one or more processors in communication with the memory, the one or more processors configured to:
detect, using ultrawide band (UWB), engagement of the smart home device by the wearable device;
initiate, in response to detecting the engagement, a control mode;
receive signals from the wearable device, the signals corresponding to a command associated with gestures detected by the wearable device;
perform an action associated with the command;
detect disengagement of the wearable device; and
exit the control mode.

12. The system of claim 11, wherein detecting the engagement of the smart home device comprises detecting a relative position of the wearable device with respect to the smart home device.

13. The system of claim 12, wherein detecting the relative position comprising determining that the relative position has remained unchanged for a predetermined threshold of time.

14. The system of claim 12, wherein the wearable device is a smartwatch worn on the user's arm.

15. The system of claim 14, wherein the relative position is the smartwatch being pointed at the smart home device.

16. The system of claim 11, further comprising:
receiving, from a second smart home device, the wearable device as detected by the second smart home device using UWB; and
determining, based on combined UWB information from the smart home device and the second smart home device, an orientation of the user.

17. The system of claim 11, wherein initiating the control mode comprises listening, by the smart home device, for signals from the wearable device.

18. The system of claim 11, wherein detecting disengagement comprises detecting that the wearable device changed position relative to the smart home device.

19. The system of claim 11, wherein detecting disengagement comprises detecting that a predetermined threshold of time has passed after initiating the control mode.

20. A non-transitory computer-readable medium storing instructions executable by one or more processors, the instructions for performing a method of controlling a smart home device, comprising:
detecting, using ultrawide band (UWB), engagement of the smart home device by the wearable device;
initiating, in response to detecting the engagement, a control mode;
receiving signals from the wearable device, the signals corresponding to a command associated with gestures detected by the wearable device;
performing an action associated with the command;
detecting disengagement of the wearable device; and
exiting the control mode.
